(19) United States
(12) Patent Application Publication
(10) Pub. No.: US 2012/0044440 A1
(43) Pub. Date: Feb. 23, 2012

(54) LIQUID CRYSTAL DISPLAY DEVICE

(75) Inventors: Motohiro Yamahara, Nara-shi (JP); Akiyoshi Kanemitsu, Ehime (JP); Tomonori Miyamoto, Osaka (JP)

(73) Assignee: SUMITOMO CHEMICAL COMPANY, LIMITED, Chuo-ku, Tokyo (JP)

(21) Appl. No.: 13/260,883

(22) PCT Filed: Mar. 29, 2010
(86) PCT No.: PCT/JP2010/055564

§ 371 Date: Nov. 8, 2011

(30) Foreign Application Priority Data
Mar. 30, 2009 (JP) 2009-081082

(51) Int. Cl. G02F 1/1335

(52) U.S. Cl. 349/64

(57) ABSTRACT

A liquid crystal display device provided with a back light device can relieve lamp images without lowering the utilization efficiency of the light emitted from the back light device.

A liquid crystal display device 100, comprising, in sequence: a back light device 2; a first light diffusing plate 3; prism sheets 4a and 4b; a first polarizing plate 5; a liquid crystal cell 1; a second polarizing plate 6; and a second light diffusing plate 7, wherein the first polarizing plate 5 and the second polarizing plate 6 are arranged so that absorption axes thereof are in crossed Nicol relation, wherein the first light diffusing plate 3 has a characteristic that, when parallel light is made incident from the back face of the first light diffusing plate 3 in the direction of the perpendicular of the back face, the ratio (I₂₀/I₀) between the intensity (I₂₀) of the transmitted light emitted in the direction forming an angle of 20° with respect to the direction of the perpendicular, and the intensity (I₀) of the transmitted light emitted in the direction forming an angle of 0° with respect to the direction of the perpendicular is 30% or less, and the second light diffusing plate 7 has a light diffusing layer 72 comprising a translucent resin 721 and translucent fine particles 722 dispersed in the translucent resin 721.

### TECHNICAL FIELD

The present invention relates to a liquid crystal display device, and more particularly to a liquid crystal display device provided with a direct backlight device.

### BACKGROUND ART

In a liquid crystal display device provided with a so-called direct backlight device, a light diffusing plate having a milky white color is provided between a back light device with a plurality of cold-cathode tube lamps arranged in parallel, and a liquid crystal cell, to thereby suppress the generation of the lamp images due to the fact that the luminance immediately above the cold-cathode tube lamps is higher than the luminance of the other parts.

However, when the light diffusing plate is provided, the light emitted from the back light device is absorbed and reflected by the light diffusing plate. Thereby, the luminance of the light transmitted through the light diffusing plate is lowered, so that the utilization efficiency of the light emitted from the back light device is lowered.

Thus, for example, a technique has been proposed (see Patent Literature 1) in which the light-emitting surface is made uniform by relieving the lamp images in such a manner that the lamp images are blurred by a diffusion film for suitably scattering the light emitted from the back light device, and that the number of the blurred lamp images is increased by using a lens film.

### CITATION LIST

### Patent Literature

Patent Literature 1: Japanese Patent Application Laid-Open Publication No. 2004-319122

### SUMMARY OF INVENTION

### Technical Problem

In recent years, a new liquid crystal display device has been required which can relieve the lamp images without lowering the utilization efficiency of the light emitted from the back light device.

### Solution to Problem

A liquid crystal display device according to the present invention comprises, in sequence: a back light device; a first light diffusing means; a light deflecting means; a first polarizing plate; a liquid crystal cell having a liquid crystal layer provided between a pair of substrates; a second polarizing plate; and a second light diffusing means, wherein the first polarizing plate and the second polarizing plate are arranged so that absorption axes thereof are in crossed Nicol relation, wherein the first light diffusing means has a characteristic that, when parallel light is made incident from the back face of the first light diffusing means in the direction of the perpendicular of the back face, the ratio (I₂₀/I₀) between the intensity (I₂₀) of the transmitted light emitted in the direction forming an angle of 20° with respect to the direction of the perpendicular, and the intensity (I₀) of the transmitted light emitted in the direction forming an angle of 0° with respect to the direction of the perpendicular is 30% or less, and the second light diffusing means has a light diffusing layer comprising a translucent resin and translucent fine particles dispersed in the translucent resin.

It is preferred that the first light diffusing means is a light diffusing plate comprising: a light diffusing layer containing a translucent resin and a light diffusing agent dispersed in the translucent resin; and a surface layer provided on one surface or both surfaces of the light diffusing layer, and wherein the ten-point mean roughness of at least one surface of the surface layers is in a range of 20 to 60 μm. Note that the ten-point mean roughness (Rz) is a value measured in accordance with JIS B0601. It is preferred that the surface layer is provided on the surface of the light diffusing layer, the surface facing the light deflecting means.

It is preferred that the light deflecting means has a plurality of prism films provided on a light-exiting surface with a plurality of linear prisms each having a polygonal and tapered cross-section at predetermined intervals, and wherein the plurality of prism films are arranged so that a ridge line direction of linear prisms of one prism film is different from that of the other prism films.

It is preferred that the light diffusing layer of the second light diffusing means is formed on the surface of a base film, and it is preferred that the average particle size of the translucent fine particles exceeds 5 μm, and the content of the translucent fine particles is in a range of 25 to 50 parts by mass with respect to 100 parts by mass of the translucent resin. Alternatively, it is preferred that the average particle size of the translucent fine particles is 2 μm to 5 μm, and the content of the translucent fine particles is in a range of 35 to 60 parts by mass with respect to 100 parts by mass of the translucent resin.

### Advantageous Effects of Invention

The liquid crystal display device according to the present invention can relieve the lamp images without lowering the utilization efficiency of the light emitted from the back light device.

### BRIEF DESCRIPTION OF DRAWINGS

FIG. 1 is a schematic view showing an embodiment of a liquid crystal display device according to the present invention.

FIG. 2 is a schematic view showing an example of arrangement of prism films and polarizing plates.

FIG. 3 is a schematic view showing an example of a first light diffusing plate.

FIG. 4 is a schematic view showing an example of a second light diffusing plate.

FIG. 5 is a schematic view showing an embodiment formed by integrating a second polarizing plate and a second light diffusing plate.

FIG. 6 is a schematic view showing another embodiment of the liquid crystal display device according to the present invention.

FIG. 7 is a schematic view showing an apparatus for measuring the intensity of light transmitted through the first light diffusing plate.

FIG. 8 is a view showing a state of scattering of transmitted light (L) at the time when parallel light (Li) is made incident on the back face of the first light diffusing plate in the direction of the perpendicular of the back face.

FIG. 9(a) is a front view of the liquid crystal display device according to the present invention, and FIG. 9(b) is a view when the plane 14b in FIG. 9 (a) is viewed from the direction of the perpendicular of the plane 14b.

### DESCRIPTION OF EMBODIMENTS

In the following, a liquid crystal display device according to the present invention will be described with reference to the drawings, but the present invention is not limited to these embodiments in any way.

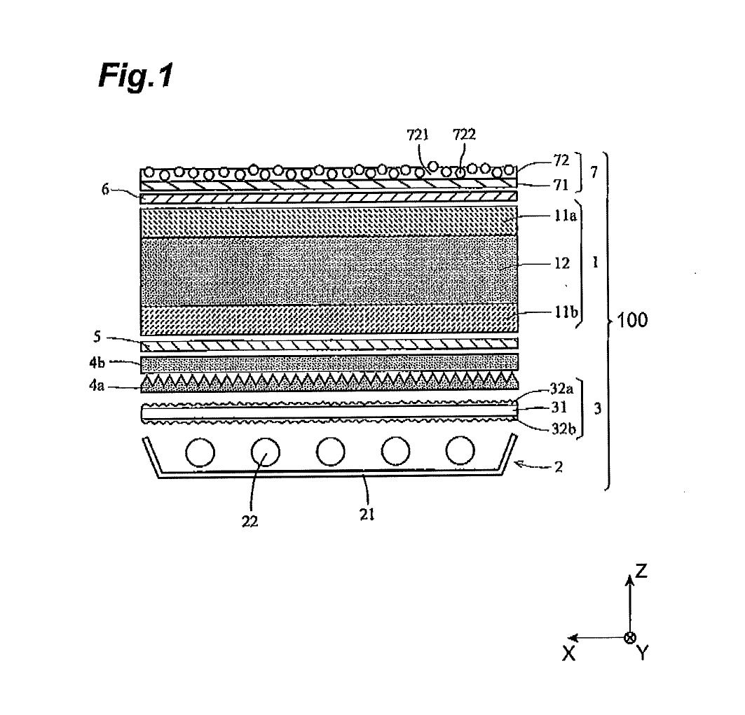

FIG. 1 shows a schematic view showing an embodiment of a liquid crystal display device according to the present invention. A liquid crystal display device 100 of FIG. 1 is a TN-mode liquid crystal display device of normally white mode, provided by arranging a back light device 2, a first light diffusing plate (first light diffusing means)₃, two sheets of prism films (light deflecting means) 4a and 4b, a first polarizing plate 5, a liquid crystal cell 1 having a liquid crystal layer 12 provided between a pair of transparent substrates 11a and 11b, a second polarizing plate 6, and a second light diffusing plate (second light diffusing means)₇, in this order. The perpendicular of the light-incident surface of the prism films 4a and 4b is set to be approximately parallel to the Z-axis. It is to be noted that, in present Description, the phrase, approximately parallel, means that the case of being perfectly parallel and the cases of deviating within an angle range of about ±5° from being parallel are included.

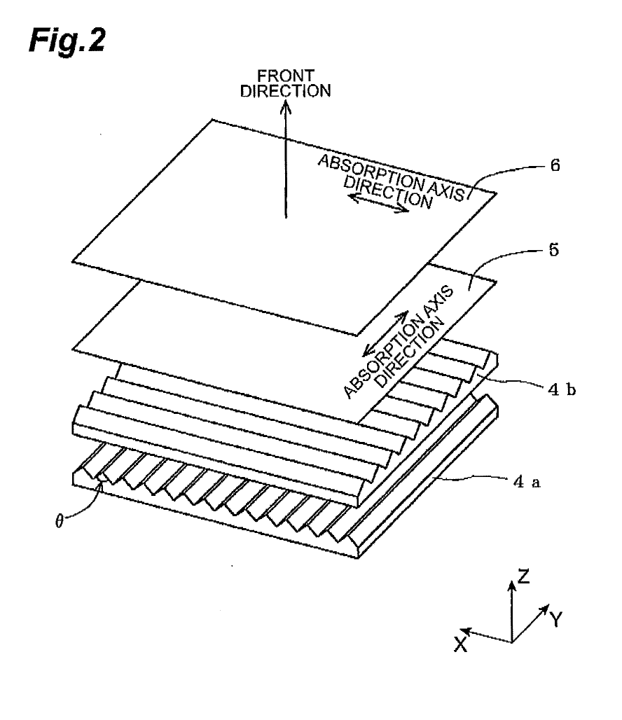

As shown in FIG. 2, the first polarizing plate 5 and the second polarizing plate 6 are arranged so that the absorption axes thereof (Y-direction and X-direction) are in crossed Nicol relation. Further, each of the two sheets of the prism films 4a and 4b has a flat light incident surface and a plurality of linear prisms having a triangle cross-section shape formed in parallel on the light emitting surface. Further, the prism film 4a is arranged so that the ridge lines of the linear prisms are approximately parallel to the absorption axis direction of the first polarizing plate 5, while the prism film 4b is arranged so that the ridge lines of the linear prisms are approximately parallel to the absorption axis direction of the second polarizing plate 6. The vertex angle θ of the linear prisms having a triangle cross-section shape is in a range from 90° to 110°. The triangle cross-section shape is optionally equilateral or inequilateral. For the purpose of condensing light in the front direction, however, an isosceles triangle is preferable. A configuration is preferred in which an adjacent isosceles triangle is sequentially arrayed adjacent to a base facing to a vertex angle, and ridge lines, which are rows of vertex angles, form long axes so as to be provided approximately parallel to each other. In this case, as long as the light condensing capability is not remarkably degraded, the vertexes and the base angles may have a curvature. The distances between the ridge lines are normally in a range from 10 μm to 500 μm and preferably in a range from 30 μm to 200 μm. Here, when viewed from the light emitting surface side, the ridge lines of the linear prisms may be either straight lines or undulate curves. In present Description, when the ridge lines are undulate curves as viewed from the light emitting surface side, the direction of the ridge lines mean the direction of a regression line obtained by a least-square method. Further, the cross-section shape of the linear prism is not limited to a triangle shape as long as the cross-section is a polygonal and tapered shape.

In the liquid crystal display device 100 configured as described above, as shown in FIG. 2, the light emitted from the back light device 2 is diffused by the first light diffusing plate 3 to such an extent that the lamp images are left as will be described below, and is then made incident on the prism film 4a. In the vertical cross section (ZX plane) orthogonal to the direction of the absorption axis of the first polarizing plate 5, the light, which is made incident obliquely on the lower surface of the prism film 4a, is subjected to a change of course to be emitted to the front direction. Next, in the prism film 4b, similarly as described above, in the vertical cross section (ZY plane) orthogonal to the direction of the absorption axis of the second polarizing plate 6, the light, which is made incident obliquely on the lower surface of the prism film 4b, is subjected to a change of course to be emitted to the front direction (Z direction). Therefore, the light transmitted through the two sheets of prism films 4a and 4b is collected in the front direction in the vertical cross sections of both, so that the luminance in the front direction is improved.

Returning to FIG. 1, the circularly polarized light, to which the directivity in the front direction is imparted, is linearly polarized by the first polarizing plate 5 to be made incident on the liquid crystal cell 1. The light, which is made incident on the liquid crystal cell 1, and the polarization plane of which is controlled by the orientation of each pixel of the liquid crystal layer 12 controlled by the electric field, is emitted from the liquid crystal cell 1. Then, the light emitted from the liquid crystal cell 1 is subjected to imaging by the second polarizing plate 6, is further diffused by the second light diffusing plate 7, and is emitted to the side of the display surface in the state where the lamp image is completely relieved.

As will be described below, in the liquid crystal display device 100 according to the present invention, the light diffusibility of the first light diffusing plate 3 is made lower than before, so as to increase the utilization efficiency of the light emitted from the back light device, and the second light diffusing plate 7 is provided, so as to relieve the lamp image without deteriorating display characteristics. Further, the forwardly directed directivity of the light made incident on the liquid crystal cell 1 is made greater than before by the two sheets of prism films 4a and 4b, so that the luminance in the front direction is improved as compared with that of the conventional device. Further, an excellent anti-glare property can also be obtained by the second light diffusing plate 7.

Each member of the liquid crystal display device according to the present invention is explained below. First, the liquid crystal cell 1 used in the present invention in FIG. 1 is provided with the pair of transparent substrates 11a and 11b and the liquid crystal layer 12, the transparent substrates 11a and 11b being oppositely arranged at a predetermined distance by a spacer not shown in the drawing, the liquid crystal layer 12 being composed of a liquid crystal encapsulated between the pair of transparent substrates 11a and 11b. Although not shown in the drawing, the pair of transparent substrates 11a and 11b is each provided with a transparent electrode and an oriented film, which are laminated. Applying a voltage based on display data between the transparent electrodes orients the liquid crystal. The display type of the liquid crystal cell 1 herein is TN, but a display type such as IPS and VA may be employed.

The backlight device 2 is provided with a rectangular parallelepiped case 21 having an opening on an upper surface and a plurality of cold-cathode tubes 22 arranged in the case 21 as a linear light source. The case 21 is formed of a resin material or a metal material. In view of reflection of the light emitted from the cold-cathode tubes 22 by the internal peripheral surface of the case, it is preferred that at least the internal peripheral surface of the case have a white color or a silver color. In addition to the cold-cathode tubes, hot-cathode tubes or linearly disposed LEDs may be used as the light source. In the case where the linear light source is used, there is no particular limit to the number of arranged linear light sources. In view of prevention of luminance unevenness of a luminescent surface, however, it is preferred that the distance between the centers of adjacent linear light sources be within a range of 15 and 150 mm. The backlight device 2 used in the present invention is not limited to a direct under type shown in FIG. 1. A conventionally known type, such as a side-light type or a planar light source type, may be used, the side-light type having a linear light source or a point light source disposed on a side surface of a light guide plate, the planar light source type having a light source itself having a flat surface shape.

The first light diffusing plate 3 has an optical characteristic that, when parallel light is made incident from the back face in the direction of the perpendicular of the back face, the ratio (I₂₀/I₀) between the intensity (I₂₀) of the transmitted light emitted in the direction forming an angle of 20° with respect to the direction of the perpendicular, and the intensity (I₀) of the transmitted light emitted in the direction forming an angle of 0° with respect to the direction of the perpendicular is 30% or less. Here, the back face is the surface of the first light diffusing plate 3, the surface facing the back light device. Light is made incident on this back face from the back light device. By the first light diffusing plate 3 having such optical characteristic, the light emitted from the back light device is diffused to such an extent that the images of the lamps are left.

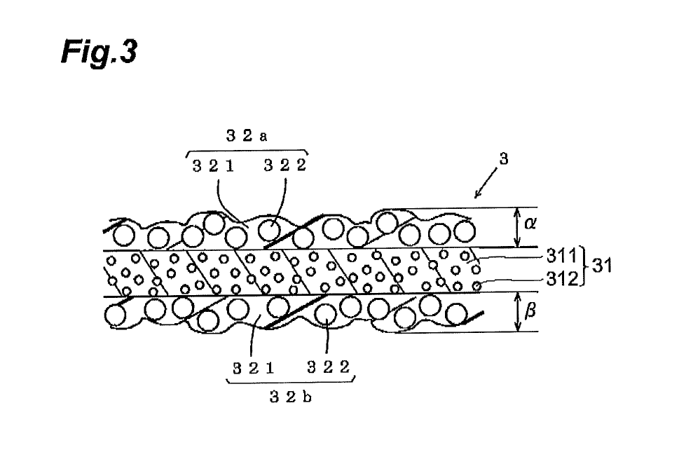

Examples of the first light diffusing plate 3 having the above-described optical characteristics include, for example, a light diffusing plate which is, as shown in FIG. 3, provided with a light diffusing layer 31, and surface layers 32a and 32b respectively formed on both surfaces of the light diffusing layer 31. The light diffusing layer 31 is formed by dispersing a light diffusing agent 312 in a translucent resin 311, and can be obtained, for example, by mixing the translucent resin 311 and the light diffusing agent 312. As the translucent resin 311, it is possible to use polycarbonates; methacrylate resins; methyl methacrylate-styrene copolymer resins; acrylonitrile-styrene copolymer resins; methacrylate-styrene copolymer resins; polystyrenes; polyvinyl chlorides; polyolefins such as polypropylene and polymethylpentene; cyclic polyolefins; polyester resins such as polyethylene terephthalate, polybutylene terephthalate, and polyethylene naphthalate; polyamide resins; polyarylates; and polyimides, and the like. The light diffusing agent 312 is fine particles composed of a material having a refractive index different from that of the translucent resin 311. Specific examples of the fine particles include organic fine particles different from the translucent resin 311, such as acrylic resins, melamine resins, polyethylenes, polystyrenes, organic silicone resins, and acrylic-styrene copolymers; and inorganic fine particles, such as calcium carbonate, silica, aluminum oxide, barium carbonate, barium sulfate, titanium oxide, and glass. One type from the materials is used, or two or more types from the materials are used as a mixture. Further, organic polymer balloons or glass hollow beads may be used. It is preferred that the average particle size of the light diffusing agent 312 is in a range of 0.5 μm to 30 μm. Further, the shape of the light diffusing agent may not only be spherical, but also be flat, platy, or acicular. It is preferred that the blending amount of the light diffusing agent 312 is set in a range of 0.1 parts by mass to 10 parts by mass with respect to 100 parts by mass of the translucent resin. It is preferred that the layer thickness of the light diffusing layer 31 is in a range of 100 μm to 5000 μm.

The surface layers 32a and 32b are formed by dispersing coarse particles 322 in a translucent resin 321, and can be obtained, for example, by the mixing translucent resin 321 with the coarse particles 322. As a material of the translucent resin 321, it is possible to use the same material as that of the translucent resin 311 of the light diffusing layer 31. As the coarse particles 322, it is possible to use inorganic and organic particles which have a particle size of 20 μm to 200 μm. It is preferred that the blending amount of the coarse particles 322 is set in a range of 15 parts by mass to 70 parts by mass with respect to 100 parts by mass of the translucent resin.

The first light diffusing plate 3 having such three-layer structure can be manufactured, for example, by a method of coextruding a light diffusing resin composition of the translucent resin 311 in which the light diffusing agent 312 is diffused, together with a coarse particle-containing resin composition of the translucent resin 321 in which the coarse particles 322 is dispersed. The co-extrusion of the light diffusing resin composition and the coarse particle-containing resin composition is performed in the same way as usual, and can be performed by coextruding the light diffusing resin composition and the coarse particle-containing resin composition from a die so that the surface layers 32a and 32b formed of the coarse particle-containing resin composition are formed on both the surfaces of the light diffusing layer 31 formed of the light diffusing resin composition. It is preferred that the layer thickness of the surface layers 32a and 32b is set in a range of 30 μm to 80 μm. Here, the layer thickness of the surface layer means the maximum thickness from the surface of the surface layers 32a and 32b in contact with the light diffusing layer 3 to the opposite surface of the surface layers 32a and 32b. Accordingly, when the surface layers 32a and 32b have asperities, the thickness of each of thickest portions corresponding to α and β in FIG. 3 is the layer thickness of each of the surface layers 32a and 32b. Further, the perpendicular of the back face of the first light diffusing plate 3 means the perpendicular of the surface of the light diffusing layer 31, which surface faces the back light device 2.

In the process in which the surface layers 32a and 32b formed of the coarse particle-containing resin composition are cooled and solidified after being extruded from the die, the coarse particles 322 are floated up to the surface of the surface layers 32a and 32b, so that a desired surface roughness is formed. It is preferred that the surface roughness of the first light diffusing plate 3, that is, the surface roughness of the surface layers 32a and 32b is adjusted so that the ten-point mean roughness (Rz) is in a range of 20 to 60 μm. The ten-point mean roughness (Rz) of the first light diffusing plate 3 can be adjusted by the particle size and the blending amount of the coarse particles 322, and by the cooling rate when cooled and solidified after being coextruded from the die. Further, when the first light diffusing plate 3 is rolled by using such a polishing roll after being coextruded from the die, the ten-point mean roughness (Rz) of the first light diffusing plate 3 can be adjusted by the rolling pressure and the like. For example, in order to increase the ten-point mean roughness (Rz), it is only necessary to increase the particle size and blending amount of the coarse particles 322, and to lower the cooling rate. Further, when the first light diffusing plate 3 is rolled, it is only necessary to reduce the rolling pressure. Note that, it is also possible to work out even when the surface roughness of only one of the surface layers 32a and 32b is adjusted so that the ten-point mean roughness (Rz) of the surface layer is in a range of 20 to 60 μm. In this case, it is preferred that the surface layer having the surface roughness adjusted in the above-described range is provided on the surface of the light diffusing layer 3, which surface faces the light deflecting means. Further, it is also possible to work out when only one of the surface layers 32a and 32b is provided on one surface of the light diffusing layer 3. In this case, it is preferred that the surface roughness of the surface layer is adjusted in the above-described range, and that the surface layer is provided on the surface of the light diffusing layer 3, which surface faces the light deflecting means. It is more preferred that both the surface layers 32a and 32b are provided.

Next, in the prism films 4a and 4b, the light incident surface is a flat plane, and a plurality of linear prisms having a triangle cross-sectional shape are formed in parallel on the light-exiting surface. Examples of the material of the prism films 4a and 4b include thermoplastic resin, such as polycarbonate resins, ABS resins, methacrylate resins, methyl methacrylate-styrene copolymer resins, polystyrene resins, acrylonitrile-styrene copolymer resins, and polyolefin resins, such as polyethylene and polypropylene. Example of the manufacturing method of the prism film include, for example, methods, such as a method in which thermoplastic resin is placed in a metallic mold and the prism film is formed by heat-press molding, or for example, a method in which an uncured ionizing radiation curable resin is filled in a metallic mold to be irradiated with ionizing radiation. Here, examples of the ionizing radiation include ultraviolet rays and the like, and examples of the ionizing radiation curable resin include a resin equivalent to an ionizing radiation curable resin exemplified as a translucent resin as will be described below. A light diffusing agent may also be dispersed in the prism films 4a and 4b. The thickness of the prism films 4a and 4b is normally 0.1 to 15 mm, preferably 0.5 to 10 mm. The prism films 4a and 4b may be formed integrally. Further, the prism films 4a and 4b formed integrally may also be bonded to the first light diffusing plate 3.

The first polarizing plate 5 and the second polarizing plate 6 generally used in the present invention are each composed of a polarizer having support films bonded on two surfaces thereof. Examples of the polarizer include a polarizer substrate in which an adsorbed dichroic dye or iodine is oriented, the polarizer substrate being composed of a polyvinyl alcohol resin, a polyvinyl acetate resin, an ethylene/vinyl acetate (EVA) resin, an polyamide resin, or a polyester resin; and a polyvinyl alcohol/polyvinylene copolymer containing an oriented molecular chain of a dichroic dehydrated product of polyvinyl alcohol, i.e. polyvinylene, in a molecularly-oriented polyvinyl alcohol film. In particular, a polarizer substrate made of polyvinyl alcohol resin in which an adsorbed dichroic dye or iodine is oriented is suitably used as the polarizer. There is no particular limit to the thickness of the polarizer. For the purpose of thinning of the polarizing plate, however, a thickness of 100 μm or less is generally preferable, more preferably a range of 10 to 50 μm, and most preferably a range of 25 to 35 μm.

As the support film that supports and protects the polarizer, a film is preferred which is composed of a polymer having low birefringence and being excellent in transparency, mechanical strength, thermal stability, and waterproof performance. Such a film may be prepared by processing a resin, for example, a cellulose acetate resin, such as TAC (triacetylcellulose); an acrylic resin; a fluorinated resin, such as a tetrafluoroethylene/hexafluoropropylene copolymer; a polycarbonate resin; a polyester resin, such as polyethylene terephthalate; a polyimide resin; a polysulfone resin; a polyether sulfone resin; a polystyrene resin; a polyvinyl alcohol resin; a polyvinyl chloride resin; a polyolefin resin; or a polyamide resin, into a film. Among these materials, a triacetylcellulose film or a norbornene thermoplastic resin film having a surface saponified with alkaline or the like is preferably used in view of a polarization property and durability. The norbornene thermoplastic resin film is suitably used in particular, since the film serves as an excellent barrier against heat and humidity, thus significantly improving the durability of the polarizing plate; and has low moisture absorption, thus significantly enhancing stability in dimensions. Molding and processing into a film shape can be performed by a conventionally known process, such as a casting method, a calendar method, or an extrusion method. There is no limit to the thickness of the support film. In view of thinning of the polarizing plate, however, a thickness of 500 μm or less is normally preferable, more preferably a range of 5 to 300 μm, and furthermore preferably a range of 5 to 150 μm.

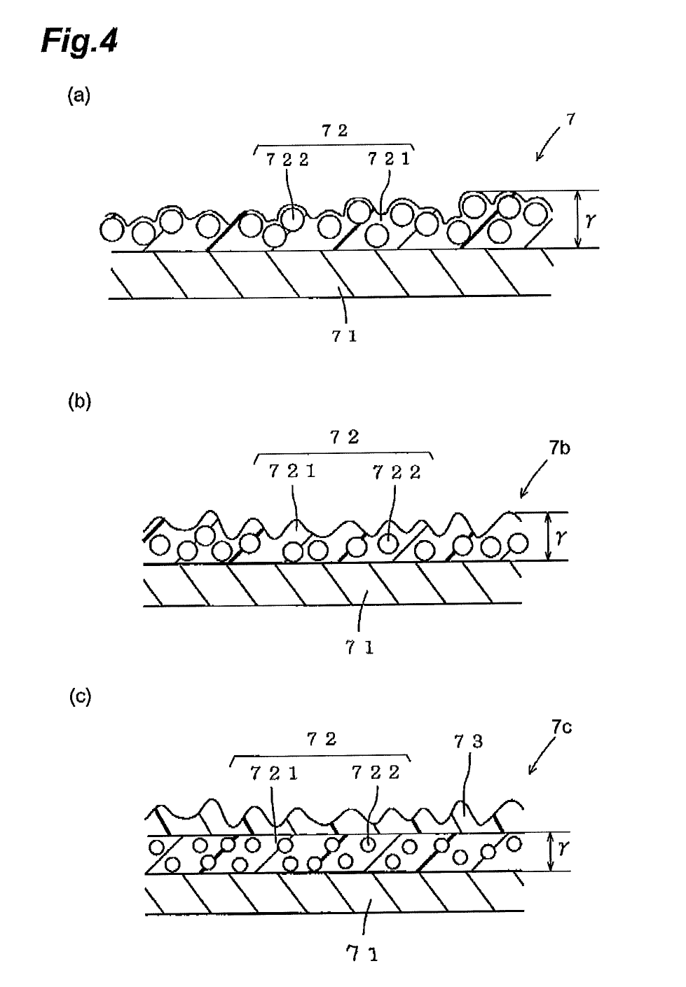

Examples of the second light diffusing plate 7 include a plate of a translucent resin in which a light diffusing agent is dispersed as the first light diffusing plate, for example, a base film 71, on one surface of which a light diffusing layer 72 with translucent fine particles 722 dispersed in a translucent resin 721 is laminated. In the following, with reference to FIG. 4(a), there will be described, as the second light diffusing plate 7, a plate which is formed in such a manner that the light diffusing layer 72 with the translucent fine particles 722 dispersed in the translucent resin 721 is laminated on one surface of the base film 71. By mixing the translucent resin and the light diffusing agent or the translucent fine particles, the light diffusing agent or the translucent fine particles can be dispersed in the translucent resin.

Here, in the case where the average particle size of the translucent fine particle 722 to be used is larger than 5 μm, it is preferred that the blending amount of the translucent fine particles 722 to the translucent resin 721 is set to 25 to 50 parts by mass with respect to 100 parts by mass of the translucent resin, and in the case where the average particle size of the translucent fine particle 722 is in a range of 2 μm to 5 μm, setting to 35 to 60 parts by mass is preferred. When the average particle size and the blending amount of the translucent fine particles 722 are set in the above-described ranges, a desired light diffusing characteristic is obtained, so that the lamp image can be effectively relieved. Further, at the same time, excellent antiglare property can also be obtained.

As the translucent fine particles 722 used in the present invention, heretofore known fine particles can be used without any particular limitation as long as the translucent fine particles have the above-described average particle size and translucency. Examples of such translucent fine particles include organic fine particles such as an acrylic resin, a melamine resin, polyethylene, polystyrene, an organic silicone resin, a acryl-styrene copolymer, and the like, and inorganic fine particles such as calcium carbonate, silica, aluminum oxide, barium carbonate, barium sulfate, titanium oxide, glass and the like; one of these is used or two or more of these are used as mixtures. Balloons of organic polymers and glass hollow beads can also be used. The shape of the translucent fine particles 722 may be any shape such as a spherical shape, a flat shape, a plate-like shape and a needle-like shape; particularly preferable is a spherical shape.

The refractive index of the translucent fine particles 722 is preferably set to be larger than the refractive index of the translucent resin 721; the difference between these refractive indexes is preferably in a range from 0.04 to 0.1. By setting the difference between the refractive index of the translucent fine particles 722 and the refractive index of the translucent resin 721 so as to fall within the above-described range, the light incident on the light diffusing layer 72 can undergo not only the development of the surface scattering due to the asperities of the light diffusing layer surface but the development of the internal scattering due to the refractive index difference between the translucent fine particles 722 and the translucent resin 721, and hence the occurrence of scintillation can be suppressed. It is preferable that the refractive index difference is 0.1 or less, since when the refractive index difference is 0.1 or less, the whitening of the second light diffusing plate 7 tends to be suppressed.

As the translucent resin 721 used in the present invention, such resins that have translucency can be used without any particular limitation; examples of such usable resins include: ionizing radiation curable resins such as ultraviolet curable resins and electron beam curable resins; thermocurable resins; thermoplastic resins; and metal alkoxides. Among these, preferred are the ionizing radiation curable resins from the viewpoint that the ionizing radiation curable resins have a high hardness and impart a sufficient scratch resistance to the second light diffusing plate 7 disposed on the display surface.

Examples of the ionizing radiation curable resin include multifunctional acrylates such as the acrylic acid esters or the methacrylic acid esters of polyhydric alcohols, multifunctional urethane acrylates such as synthesized from a diisocyanate, a polyhydric alcohol and a hydroxyester of an acrylic acid or methacrylic acid; and the like. In addition to these, polyether resin, polyester resin, epoxy resin, alkyd resin, spiroacetal resin, polybutadiene resin, polythiol-polyene resin having acrylate based functional groups, and the like can also be used.

When of the ionizing radiation curable resins, an ultraviolet curable resin is used, a photopolymerization initiator is added. Any photopolymerization initiator may be used, and it is preferable to use a photopolymerization initiator suitable for the resin used. As the photopolymerization initiator (radical polymerization initiator), benzoin and the alkyl ethers of benzoin such as benzoin, benzoin methyl ether, benzoin ethyl ether, benzoin isopropyl ether and benzyl methyl ketal are used. The used amount of the photosensitizer is 0.5 to 20 wt % and is preferably 1 to 5 wt % in relation to the resin.

Examples of the thermocurable resin include a thermocurable urethane resin made of an acrylic polyol and an isocyanate prepolymer, a phenolic resin, a urea-melamine resin, an epoxy resin, an unsaturated polyester resin and a silicone resin.

As the thermoplastic resin, cellulose derivatives such as acetyl cellulose, nitrocellulose, acetyl butyl cellulose, ethyl cellulose and methyl cellulose; vinyl resins such as vinyl acetate and the copolymers thereof, vinyl chloride and the copolymers thereof, vinylidene chloride and the copolymers thereof; acetal resins such as polyvinyl formal and polyvinyl butyral; acryl-based resins such as acrylic resins and the copolymers thereof and methacrylic resins and the copolymers thereof; polystyrene resin, polyamide resin, linear polyester resin, polycarbonate resin and the like; can be used.

As the metal alkoxide, a silicon oxide based matrix made from a silicon alkoxide based material as a raw material can be used. Specific examples of the metal alkoxide include tetramethoxysilane and tetraethoxysilane, and from them, inorganic matrices or organic inorganic composite matrices can be formed by hydrolysis and dehydration condensation.

When an ionizing radiation curable resin is used as the translucent resin 721, it is necessary to irradiate the applied resin with an ionizing radiation such as ultraviolet light or an electron beam after the ionizing radiation curable resin is applied to the substrate film 71 and dried. When a thermocurable resin or a metal alkoxide is used as the translucent resin 721, heating is required after application and drying, as the case may be.

In present Description, the term “the layer thickness of the light diffusing layer” means the maximum thickness between the surface of the light diffusing layer in contact with the substrate film and the opposite surface of the light diffusing layer. Accordingly, when the light diffusing layer has asperities in the second light diffusing plate 7, the thickest portion corresponding to γ shown in FIG. 4(a) defines the layer thickness of the light diffusing layer. It is preferable that the layer thickness γ of the light diffusing layer 72 is one or more and three or less times the average particle size of the translucent fine particles 722. When the layer thickness γ of the light diffusing layer 72 is less than one times the average particle size of the translucent fine particles 722, the texture of the obtained the second light diffusing plate 7 becomes coarse, and at the same time scintillation tends to occur to degrade the visibility of the display screen. On the other hand, when the layer thickness γ of the light diffusing layer 72 exceeds three times the average particle size of the translucent fine particles 722, it is difficult to form asperities on the surface of the light diffusing layer 72. The layer thickness γ of the light diffusing layer 72 is preferably in a range from 5 to 25 μm. When the layer thickness γ of the light diffusing layer 72 is less than 5 μm, no scratch resistance sufficient for the light diffusing layer 72 to be disposed on the display surface may be obtained, and on the other hand, when the layer thickness γ of the light diffusing layer 72 exceeds 25 μm, the curling degree of the prepared second light diffusing plate 7 may come to be large to degrade the handleability.

The substrate film 71 used in the second light diffusing plate 7 is only required to be translucent; as the substrate film 71, for example, glass or plastic films can be used. Such plastic films are only required to have a moderate transparency and a moderate mechanical strength. Examples thereof include cellulose acetate based resins such as TAC (triacetyl cellulose), acrylic resins, polycarbonate resins and polyester based resins such as polyethylene terephthalate.

The second light diffusing plate 7 of the present invention is prepared, for example, as follows. The substrate film 71 is coated with a resin solution in which the translucent fine particles 722 are dispersed, the coating film thickness is regulated so as for the translucent fine particles 722 to appear on the coating film surface, and thus fine asperities are formed on the substrate surface. In this case, the dispersion of the translucent fine particles 722 is preferably an isotropic dispersion.

For the purpose of improving the coatability, of improving the adhesion with the light diffusing layer and the like, the substrate film 71 may be subjected to a surface treatment before the application of the resin solution. Specific examples of the surface treatment include a corona discharge treatment, a glow discharge treatment, an acid treatment, an alkali treatment and an ultraviolet light irradiation treatment.

The method for applying the resin solution to the substrate film 71 is not limited, and for example, a gravure coating method, a microgravure coating method, a roll coating method, a rod coating method, a knife coating method, an air knife coating method, a kiss coating method, a die coating method the following methods and the like, can be used.

After the resin solution is applied to the substrate film 71 directly or through the intermediary of another layer, the solvent is dried by heating if necessary. Next, the coating film is cured with ionizing radiation and/or heat. The type of the ionizing radiation in the present invention is not particularly limited; depending on the type of the translucent resin 721, the ionizing radiation can be appropriately selected from ultraviolet light, electron beam, near ultraviolet light, visible light, near infrared light, infrared light, X-ray and the like; ultraviolet light and electron beam are preferable, and ultraviolet light is particularly preferable because the handling thereof is easy and simple and high energy is easily obtained.

As the light source of the ultraviolet light for photopolymerizing an ultraviolet curable compound, any light source generating ultraviolet light can be used. For example, a low-pressure mercury lamp, a medium-pressure mercury lamp, a high-pressure mercury lamp, an ultra-high-pressure mercury lamp, a carbon arc lamp, a metal halide lamp, a xenon lamp and the like can be used. An ArF excimer laser, a KrF excimer laser, an excimer lamp or synchrotron radiation or the like can also be used. Among these, the ultra-high-pressure mercury lamp, the high-pressure mercury lamp, the low-pressure mercury lamp, the carbon arc, the xenon arc and the metal halide lamp can be preferably used.

Similarly, the electron beam can also be used as the ionizing radiation for curing the coating film. Examples of the electron beam include the electron beams having an energy of 50 to 1000 keV and preferably 100 to 300 keV, emitted from various electron beam accelerators such as a Cockroft-Walton type accelerator, a Van de Graaf type accelerator, a resonance transformer type accelerator, an insulated core transformer type accelerator, a linear type accelerator, a Dynamitron type accelerator and a high-frequency type accelerator.

Other embodiments of the second light diffusing plate 7 are shown in FIG. 4(b) and FIG. 4(c). A second light diffusing plate 7b shown in the FIG. 4(b) is formed by laminating, on one surface side of the base film 71, the light diffusing layer 72 with the translucent fine particles 722 dispersed in the translucent resin 721, and fine asperities are formed on the surface of the light diffusing layer 72 by sandblast or the like. For the purpose of forming the fine asperities on the surface of the light diffusing layer 72, emboss shaping processing or the like or a method in which by using a casting mold having a mold surface provided with reversed asperities or an emboss roll, fine asperities are formed in the step of preparing the light diffusing layer 72. The second light diffusing plate 7c shown in the FIG. 4(c) is formed by laminating a translucent resin layer 73, having fine asperities formed on the surface thereof, on the light diffusing layer 72 provided by dispersing the translucent fine particles 722 in the translucent resin 721. In the case of the FIG. 4(b), the layer thickness γ of the light diffusing layer is a maximum thickness from the surface of the light diffusing layer in contact with the base film to the opposite surface having the asperities formed thereon. In the case of the FIG. 4(c), the layer thickness γ of the light diffusing layer is a maximum thickness from the surface of the light diffusing layer 72 in contact with the base film to the opposite surface in contact with the translucent resin layer 73.

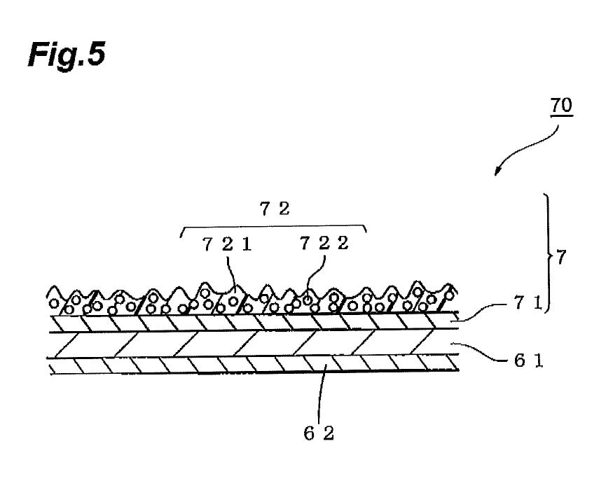

Further, as shown in FIG. 5, the second light diffusing plate 7 may also be used as a support film of the second polarizing plate. The polarizing plate usually has a structure in which a support film 62 is bonded to both surfaces of a polarizer 61. The laminated film 70 shown in FIG. 5 uses the second light diffusing plate 7 as one of the support film of the polarizer 61 of the polarizing plate, and is a multifunctional film having a polarizing function and a light diffusing function. That is, the support film 62 is bonded to one surface of the polarizer 61 and the second light diffusing plate 7, prepared by forming on the substrate film 71 the light diffusing layer 72 having fine asperities formed on the surface thereof, is bonded to the other surface of the polarizer 61. When the laminated film 70 having such a configuration and functioning as a polarizing plate is fixed to a liquid crystal display device, the laminated film 70 is bonded to the glass substrate or the like of the liquid crystal display panel so as for the second light diffusing plate 7 to be placed on the light emitting side. The support film 71 and the polarizer 61 may be bonded to each other through the intermediary of an adhesive layer, but is preferably bonded to each other directly without the intermediary of any adhesive layer. Further, from a viewpoint of effectively bonding the base film 71 to the polarizer 61, it is preferred that the base film 71 is subjected to hydrophilization treatment, such as acid treatment or alkali treatment.

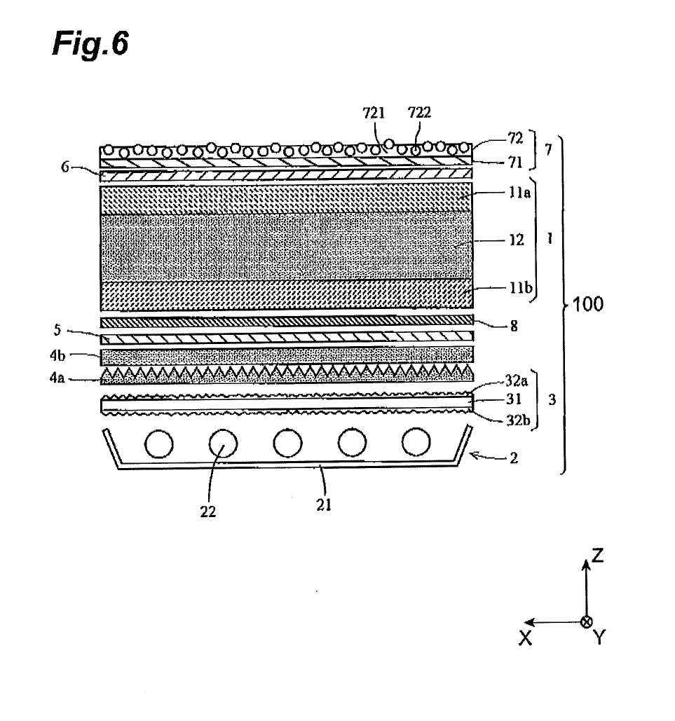

An alternative embodiment of a liquid crystal display device according to the present invention is shown in FIG. 6. The liquid crystal display device 100 in FIG. 6 is different from the liquid crystal display device 100 in FIG. 1 in that a retardation film 8 is arranged between the first polarizing plate 5 and the liquid crystal cell 1. The retardation film 8 substantially has no phase difference in the perpendicular direction to the surface of the liquid crystal cell 1, and has no optical effect from the front, but exhibits a phase difference from an oblique view, thus compensating for the phase difference generated in the liquid crystal cell 1. Thereby, more excellent display quality and color reproducibility are achieved in a wider view angle. The retardation film 8 may be arranged either or both between the first polarizing plate 5 and the liquid crystal cell 1 or/and between the second polarizing plate 6 and the liquid crystal cell 1.

Examples of the retardation film 8 include a polycarbonate resin or cyclic olefin copolymer resin formed into a film which is then a biaxially-stretched, and a liquid crystal monomer undergoing photopolymerization reaction to fix its molecular arrangement. The retardation film 8, which is used for optical compensation of the liquid crystal arrangement, is composed of a material having a refractive index characteristic opposite to the liquid crystal arrangement. Specifically, for example, a “WV Film” (manufactured by Fujifilm Corporation) is preferably used for a TN-mode liquid crystal display cell; an “LC Film” (manufactured by Nippon Oil Corporation) for an STN-mode liquid crystal display cell; a biaxial retardation film for an IPS-mode liquid crystal cell; a retardation plate combining an A plate and a C plate, or a biaxial retardation film for a VA-mode liquid crystal cell; and an “OCB WV Film” (manufactured by Fujifilm Corporation) for a π cell mode liquid crystal cell.

### EXAMPLES

In the following, the present invention will be described in more detail with reference to examples, but the present invention is not limited to these examples in any way.

(Preparation of First Light Diffusing Plate A)

The first light diffusing plate having the three-layer structure with the surface layers 32a and 32b respectively laminated on both surfaces of the light diffusing layer 31 as shown in FIG. 3, was manufactured as follows.

(Preparation of Master-Batch of Light Diffusing Layer)

Polystyrene resin pellets (“HRM40” manufactured by Toyo Styrene Co., Ltd., refractive index: 1.59) 54 parts by mass, acrylic-based polymer particles (cross-linked polymer particles, “Sumipex XC1A” manufactured by Sumitomo Chemical Co., Ltd., refractive index: 1.49, volume average particle size: 25 μm) 40 parts by mass, siloxane-based polymer particles (cross-linked polymer particles, “Torayfil DY33-719” manufactured by Dow Corning Toray Co., Ltd., refractive index: 1.42, volume average particle size: 2 μm) 4 parts by mass, ultraviolet ray absorbent (“Sumisorb 200” manufactured by Sumitomo Chemical Co., Ltd.) 2 parts by mass, and processing stabilizer (“Sumilizer GP” manufactured by Sumitomo Chemical Co., Ltd.) 2 parts by mass were dry blended and then supplied to a twin screw extruder from a hopper to be kneaded while being heated and molten, extruded in a strand shape at 250° C., and was cut into a pellet shape, so that a master-batch (having the pellet shape) of the light diffusing layer was obtained.

(Preparation of Composition for Surface Layer)

Styrene-methyl methacrylate copolymer resin (“MS200NT” manufactured by Nippon Steel Chemical Co., Ltd., styrene unit: 80% by mass, methyl methacrylate unit: 20% by mass, refractive index: 1.57) 68.8 parts by mass, acrylic-based polymer particles (cross-linked polymer particles, “MBX80” made by Sekisui Plastics Co., Ltd., refractive index: 1.49, volume average particle size: 80 μm) 30 parts by mass, thermostabilizer (“Sumisorb 200” manufactured by Sumitomo Chemical Co., Ltd.) 2 parts by mass, processing stabilizer (“Sumilizer GP” manufactured by Sumitomo Chemical Co., Ltd.) 0.2 parts by mass, and ultraviolet ray absorbent (“Adekastab LA-31” manufactured by Asahi Denka Co., Ltd.) 1.0 parts by mass were dry blended, so that a composition for the surface layer was obtained.

(Preparation of First Light Diffusing Plate A)

Polystyrene resin pellets (“HRM40” manufactured by Toyo Styrene Co., Ltd., refractive index: 1.59) 95 parts by mass, and 5 parts by mass of the master-batch of light diffusing layer manufactured as described above were dry blended, and then supplied to an extruder having a screw size of 40 mm, so that a resin composition for the light diffusing layer in a heated molten state was obtained. On the other hand, the composition for the surface layer manufactured as described above was supplied to an extruder having a screw size of 20 mm, so that a resin composition for the surface layer in a heated molten state was obtained. Then, the resin composition for the light diffusing layer, and the resin composition for the surface layer were sent to a feed block (2-kind 3-layer structure) and were further co-extruded through a T die at 245° C. to 250° C., and at a width of 220 mm, so that a first light diffusing plate A which has a three-layer structure with the surface layer (having a thickness of 0.05 mm) laminated on both the surfaces of the light diffusing layer (having a thickness of 1.9 mm), and which has a thickness of 2 mm and a rough surface on both surfaces thereof, was prepared.

(Intensity Measurement of Transmitted Light)

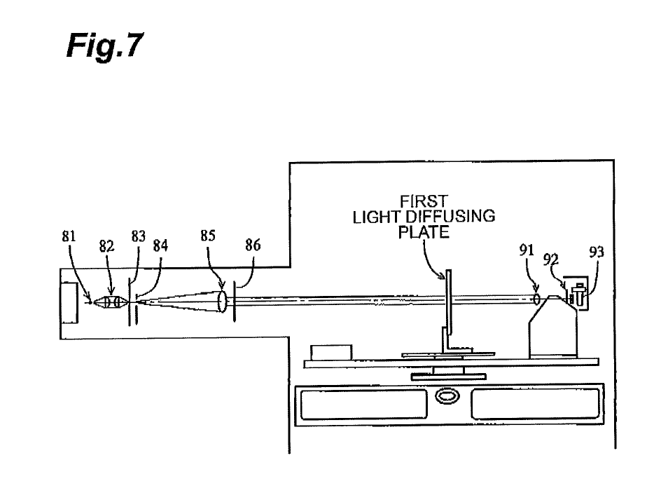

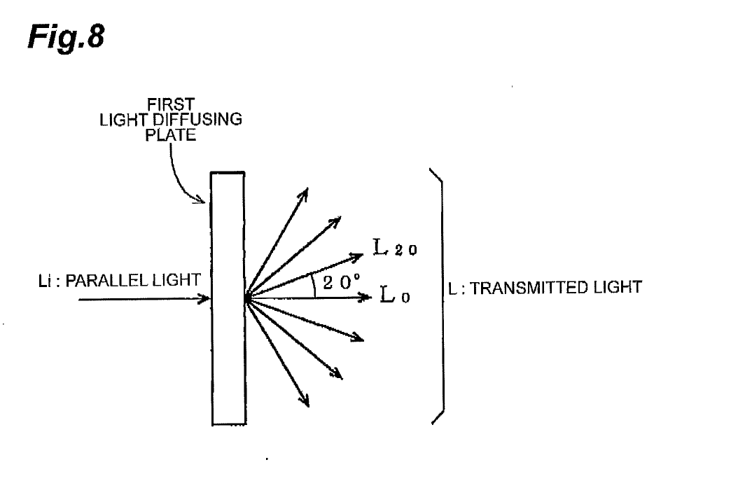

The intensity of light transmitted through the prepared first light diffusing plate A was measured by using an automatic variable angle photometer (“GP230” manufactured by Murakami Color Research Laboratory Co, Ltd.). Specifically, as shown in FIG. 7, the intensity of the light was measured at every 0.1° in such a manner that a light beam emitted from a halogen lamp 81 as a light source was transmitted through a condenser lens 82, a pinhole 83, a shutter 84, and a collimator lens 85, and was made as a parallel light having a diameter of about 3.5 mm by a luminous flux aperture 86, and that the parallel light was irradiated perpendicularly to the back face of the prepared first light diffusing plate, and the diffusion light transmitted through the first light diffusing plate was received by a photomultiplier tube 93 through a light receiving aperture 92 having a diameter of 2.8 mm and provided behind a light receiving lens 91. The distance between the first light diffusing plate and the light receiving lens 91 was set to 170 mm. FIG. 8 is a figure showing a state of scattering of transmitted light (L) when parallel light (Li) was made incident on the back face of the first light diffusing plate in the direction of the perpendicular of the back face. In the transmitted light (L), the ratio (I₂₀/I₀) of the intensity (I₂₀) of the transmitted light (L₂₀) emitted in the direction forming an angle of 20° with respect to the perpendicular, to the intensity (I₀) of the transmitted light (L₀) emitted in the direction forming an angle of 0° with respect to the perpendicular was 24.0%, for the first light diffusing plate A. The measurement results are shown in Table 1.

(Measurement of Total Light Transmittance Tt)

The total light transmittance Tt of the prepared first light diffusing plate was measured according to JIS K 7361 by using a haze transmittance meter (HR-100, manufactured by Murakami Color Research Laboratory). The measurement result is shown in Table 1.

(Measurement of Ten-Point Mean Roughness Rz)

The ten-point mean roughness Rz of one surface of the prepared first light diffusing plate was measured according to JIS B0601-1994 by using a measuring instrument “Surftest SJ-201P” manufactured by Mitutoyo Corporation. The measurement result is shown in Table 1.

(Preparation of First Light Diffusing Plate B)

In the preparation of the composition for the surface layer, a first light diffusing plate B was prepared similarly to the first light diffusing plate A except that the use amount of styrene-methyl methacrylate copolymer resin (“MS200NT” manufactured by Nippon Steel Chemical Co., Ltd.) was set to 58.8 parts by mass, and that 40 parts by mass of cross-linked polymer particles “MBX80” manufactured by Sekisui Plastics Co., Ltd. (refractive index: 1.49, volume average particle size: 80 μm) was used as acrylic-based polymer particles. Then, similarly to the above, the intensity of the light transmitted through the first light diffusing plate B, and the total light transmittance Tt and the ten-point mean roughness Rz of the first light diffusing plate B were measured. The results are shown in Table 1 together.

(Preparation of First Light Diffusing Plate C)

In the preparation of the composition for the surface layer, a first light diffusing plate C was prepared similarly to the first light diffusing plate A except that the use amount of styrene-methyl methacrylate copolymer resin (“MS200NT” manufactured by Nippon Steel Chemical Co., Ltd.) was set to 58.8 parts by mass, and that 40 parts by mass of cross-linked polymer particles “Sumipex XC1A” manufactured by Sumitomo Chemical Co., Ltd. (refractive index: 1.49, volume average particle size: 25 μm) was used as acrylic-based polymer particles. Then, similarly to the above, the intensity of the light transmitted through the first light diffusing plate C, and the total light transmittance Tt and the ten-point mean roughness Rz of the first light diffusing plate C were measured. The results are shown in Table 1 together.

TABLE 1

| First light | | Total light | Ten-point mean |
|---|---|---|---|
| diffusing plate | I₂₀/I₀ | transmittance Tt (%) | roughness Rz (μm) |
| A | 24.0% | 59.8 | 51.7 |
| B | 25.0% | 60.0 | 59.9 |
| C | 23.1% | 59.6 | 32.8 |

(Preparation of Prism Sheet)

A plate having a thickness of 1 mm was prepared by press molding a styrene resin (refractive index: 1.59) with a metallic mold having a mirror-finished surface. Further, a prism sheet was prepared by again press molding the styrene resin plate by using a metallic mold provided with parallel V-shaped linear grooves having an isosceles triangular cross section of a vertex angle θ of 95° and a distance between ridge lines of 50 μm. Further, prism sheets respectively having vertex angles θ of 95° and 100° were similarly formed.

(Preparation of Second Light Diffusing Plate (i))

### (1) Preparation of Mold for Embossing

An iron roll (JIS STKM13A) of 200 mm in diameter the surface of which was subjected to copper ballard plating was prepared. The copper ballard plating was composed of a cooper plating layer/a thin silver plating layer/a surface copper plating layer, and the thickness of the whole plating layers was approximately 200 μm. The surface of the copper plating layer was subjected to mirror polishing, further the polished surface was blasted by using a blasting apparatus (manufactured by Fuji Manufacturing Co., Ltd) with the zirconia beads TZ-B125 (average particle size: 125 μm, manufactured by Tosoh Corp.) as the first fine particles, under the conditions that the blast pressure was 0.05 MPa (the gauge pressure, as is also the case for what follows) and the used amount of the fine particles was 16 g/cm² (the used amount per 1 cm² of the surface area of the roll, as is also the case in what follows), and thus asperities were formed on the surface. The surface having asperities was blasted by using the blasting apparatus (manufactured by Fuji Seisakusho K.K.) with the zirconia beads TZ-SX-17 (average particle size: 20 μm, manufactured by Tosoh Corp.) as the second fine particles, under the conditions that the blast pressure was 0.1 MPa and the used amount of the fine particles was 4 g/cm², and thus the surface asperities were finely regulated. The obtained copper-plated iron roll with asperities was subjected to an etching treatment with a cupric chloride solution. In this etching, the etching magnitude was set to be 3 μm. Then, a chromium plating processing was performed to prepare a mold. In this case, the thickness of the chromium plating was set to be 4 μm. The Vickers hardness of the chromium plating surface of the obtained mold was 1000. The Vickers hardness was measured by using an ultrasonic hardness meter MIC10 (Krautkramer Corp.) in accordance with JIS Z 2244 (in the following examples, the method for measuring the Vickers hardness is the same).

### (2) Preparation of Second Light Diffusing Plate (i) Having Light Diffusing Layer and Base Film

Pentaerythritol triacrylate (60 parts by mass) and a multifunctional urethanated acrylate (a reaction product between hexamethylene diisocyanate and pentaerythritol triacrylate, 40 parts by mass) were mixed in an ethyl acetate solution, the resulting solution was regulated so as to have a solid content concentration of 60%, and thus an ultraviolet curable resin composition was obtained. The refractive index of the cured product obtained by ultraviolet curing after removing ethyl acetate from the composition was found to be 1.53.

Next, to 100 parts by mass of the solid content of the ultraviolet curable resin composition, 40 parts by mass of polystyrene based particles (manufactured by Sekisui Plastics Co., Ltd., refractive index: 1.59) having an average particle size of 2.0 μm as translucent fine particles and 5 parts by mass of “Lucirin TPO” (chemical name: 2,4,6-trimethylbenzoyl diphenyl phosphine oxide, manufactured by BASF Ltd.) serving as a photopolymerization initiator were added; the resulting mixture was diluted with ethyl acetate so as for the solid content to be 50%, and thus a coating solution was prepared. The coating solution was applied onto an 80-μm thick triacetyl cellulose (TAC) film (substrate film) and was dried for 1 minute in a dryer set at 80° C. The substrate film having been dried was closely attached onto the surface with asperities of the mold prepared as described above, by pressing the substrate film against the mold with a rubber roll so as for the ultraviolet curable resin composition layer to face the mold. Under this condition, from the substrate film side, irradiation with the light from a high-pressure mercury lamp at an intensity of 20 mW/cm² was performed such that the irradiation light intensity was 300 mJ/cm² in terms of the light intensity at the h-line, thus the ultraviolet curable resin composition layer was cured, and consequently the second light diffusing plate (i) composed of the layer (light diffusing layer) having asperities on the surface thereof and the substrate film, and having the structure shown in FIG. 4(b) was prepared. The layer thickness of the light diffusing layer was 13.0 μm. The haze value of the second light diffusing plate (i) was measured with a haze computer (HGM-2DP, manufactured by Suga Test Instruments Co., Ltd.) in accordance with JIS-K-7105. The result thus obtained is shown in Table 2.

(Preparation of Second Light Diffusing Plate (ii))

A second light diffusing plate (ii) was prepared similarly to the second light diffusing plate (i) except that 40 parts by mass of polystyrene-based particles (manufactured by Sekisui Plastics Co., Ltd., refractive index: 1.59) having an average particle size of 4.0 μm were used as translucent fine particles. Then, the haze value of the second light diffusing plate (ii) was measured similarly to the above. The measurement result is shown in Table 2.

(Preparation of Second Light Diffusing Plate (iii))

A second light diffusing plate (iii) was prepared similarly to the second light diffusing plate (i) except that 60 parts by mass of polystyrene-based particles (manufactured by Sekisui Plastics Co., Ltd., refractive index: 1.59) having an average particle size of 4.0 μm were used as translucent fine particles. Then, the haze value of the second light diffusing plate (iii) was measured similarly to the above. The measurement result is shown in Table 2.

(Preparation of Second Light Diffusing Plate (iv))

A second light diffusing plate (iv) was prepared similarly to the second light diffusing plate (i) except that 35 parts by mass of polystyrene-based particles (manufactured by Sekisui Plastics Co., Ltd., refractive index: 1.59) having an average particle size of 8.0 μm were used as translucent fine particles. Then, the haze value of the second light diffusing plate (iv) was measured similarly to the above. The measurement result is shown in Table 2.

(Preparation of Second Light Diffusing Plate (v))

A second light diffusing plate (v) was prepared similarly to the second light diffusing plate (i) except that 30 parts by mass of polystyrene-based particles (manufactured by Sekisui Plastics Co., Ltd., refractive index: 1.59) having an average particle size of 12.0 μm were used as translucent fine particles. Then, the haze value of the second light diffusing plate (v) was measured similarly to the above. The measurement result is shown in Table 2.

TABLE 2

| | Translucent fine particle | | | |
|---|---|---|---|---|
| Second light | Average particle | Refractive | Use amount | Haze |
| diffusing plate | size (μm) | index | (parts by mass)*¹ | value |
| (i) | 2.0 | 1.59 | 40 | 47.6 |
| (ii) | 4.0 | 1.59 | 40 | 48.7 |
| (iii) | 4.0 | 1.59 | 60 | 60.2 |
| (iv) | 8.0 | 1.59 | 35 | 62.0 |
| (v) | 12.0 | 1.59 | 30 | 61.4 |

*¹Use amount (parts by mass) to 100 mass parts of solid content of ultraviolet curable resin composition

### Examples 1 to 5

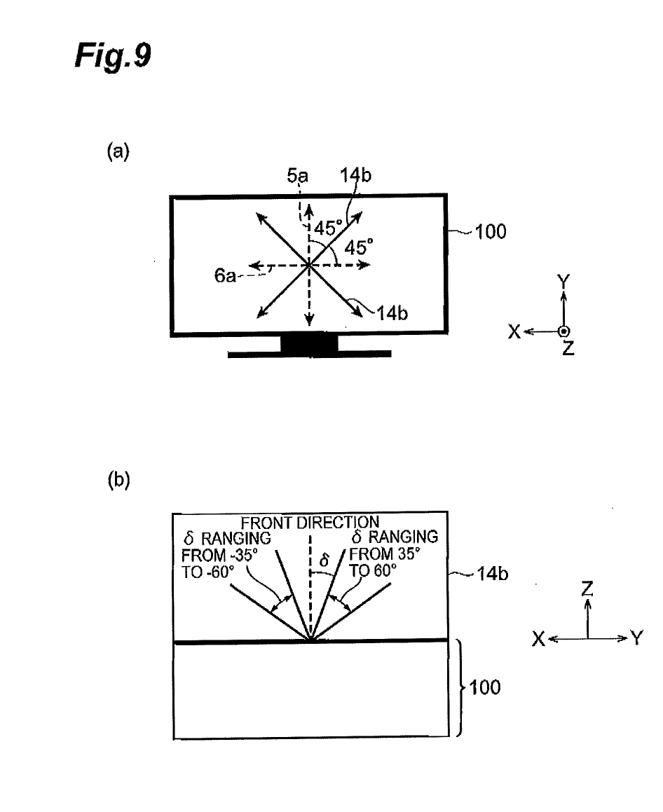

In the backlight of 32-inch IPS (In-Plane Switching) type liquid crystal television “VIERA TH-32LZ85” manufactured by former Matsushita Electric Industrial Co., Ltd. (Panasonic Co., Ltd.), the first light diffusing plate A was used as the first light diffusing means, and two prism sheets having the vertex angle of 90° were used as the light deflecting means. The first light diffusing plate A was arranged so that its surface subjected to the measurement of ten-point mean roughness was made to face the prism sheet. Then, the polarizing plate bonded to the both surfaces of the liquid crystal cell was removed, and an ordinary iodine-based polarizing plate “TRW842AP7” manufactured by Sumitomo Chemical Co., Ltd. was bonded to the both surfaces of the liquid crystal cell so that the absorption axes of the first polarizing plate and the second polarizing plate were in a crossed Nicol relationship, and so that the absorption axes of the polarizing plates were respectively parallel to the short side and the long side of the liquid crystal cell. The arrangement of the prism films and the polarizing plates was the same as in FIG. 2. Each of the second light diffusing plates (i) to (v) (Examples 1 to 5) prepared as described above was further bonded to the light emitting surface side of the second polarizing plate, so that a liquid crystal display device (having the configuration shown in FIG. 1) comprising, from the front side, the second light diffusing plate, the second polarizing plate, the liquid crystal cell, the first polarizing plate, the two prism sheets, the first light diffusing plate, the back light device was prepared. The presence or absence of lamp images was visually observed at predetermined view angles. The results are shown in Table 3. Here, the view angle means, as shown in FIG. 9(a) and FIG. 9(b), an angle δ formed with respect to the front direction (Z direction) in a plane 14b which is in parallel with each of the directions forming an angle of about 45° with respect to the transmission axis 5a of the first polarizing plate and with respect to the transmission axis 6a of the second polarizing plate, and which is in parallel with the front direction (Z direction).

### Reference Example 1

A liquid crystal display device was prepared similarly to Example 1 except that the second light diffusing plate was not bonded to the light emitting surface side of the second polarizing plate, and the presence or absence of lamp images was visually observed at the predetermined view angles. The results are shown in Table 3 together.

TABLE 3

| | | | | | | | Reference |
|---|---|---|---|---|---|---|---|
| | | Example 1 | Example 2 | Example 3 | Example 4 | Example 5 | example 1 |
| View | Front | ⊚ | ⊚ | ⊚ | ⊚ | ⊚ | X |
| angle | 30° | ⊚ | ⊚ | ⊚ | ⊚ | ⊚ | X |
| | 60° | ◯ | ⊚ | ⊚ | ⊚ | ⊚ | X |

⊚: No lamp image is viewed.
◯: Lamp image is viewed when carefully viewed.
X: Lamp image is blurred but viewed as remaining.

### Examples 6 to 10

Liquid crystal display devices were prepared similarly to Examples 1 to 5 except that the first light diffusing plate B was used as the first light diffusing means, and the presence or absence of lamp images was visually observed at the predetermined view angles. The results are shown in Table 4.

### Reference Example 2

A liquid crystal display device was prepared similarly to Example 6 except that the second light diffusing plate was not bonded to the light emitting surface side of the second polarizing plate, and the presence or absence of lamp images was visually observed at the predetermined view angles. The results are shown in Table 4 together.

TABLE 4

| | | | | | | | Reference |
|---|---|---|---|---|---|---|---|
| | | Example 6 | Example 7 | Example 8 | Example 9 | Example 10 | example 2 |
| View | Front | ⊚ | ⊚ | ⊚ | ⊚ | ⊚ | X |
| angle | 30° | ⊚ | ⊚ | ⊚ | ⊚ | ⊚ | X |
| | 60° | ◯ | ⊚ | ⊚ | ⊚ | ⊚ | X |

⊚: No lamp image is viewed.
◯: Lamp image is viewed when carefully viewed.
X: Lamp image is blurred but viewed as remaining.

### Examples 11 to 15

Liquid crystal display devices were prepared similarly to Examples 1 to 5 except that the first light diffusing plate C was used as the first light diffusing means, and the presence or absence of lamp images was visually observed at the predetermined view angles. The results are shown in Table 5.

### Reference Example 3

A liquid crystal display device was prepared similarly to Example 11 except that the second light diffusing plate was not bonded to the light emitting surface side of the second polarizing plate, and the presence or absence of lamp images was visually observed at the predetermined view angles. The results are shown in Table 5 together.

TABLE 5

| | | Example | Example | Example | Example | Example | Reference |
|---|---|---|---|---|---|---|---|
| | | 11 | 12 | 13 | 14 | 15 | example 3 |
| View | Front | ⊚ | ⊚ | ⊚ | ⊚ | ⊚ | X |
| angle | 30° | ⊚ | ⊚ | ⊚ | ⊚ | ⊚ | X |
| | 60° | ◯ | ⊚ | ⊚ | ⊚ | ⊚ | X |

⊚: No lamp image is viewed.
◯: Lamp image is viewed when carefully viewed.
X: Lamp image is blurred but viewed as remaining.

### Examples 16 to 20

Liquid crystal display devices were prepared similarly to Examples 1 to 5 except that two prism sheets having the vertex angle of 95° were used as the light deflecting means, and the presence or absence of lamp images was visually observed at the predetermined view angles. The results are shown in Table 6.

### Reference Example 4

A liquid crystal display device was prepared similarly to Example 16 except that the second light diffusing plate was not bonded to the light emitting surface side of the second polarizing plate, and the presence or absence of lamp images was visually observed at the predetermined view angles. The results are shown in Table 6 together.

TABLE 6

| | | Example | Example | Example | Example | Example | Reference |
|---|---|---|---|---|---|---|---|
| | | 16 | 17 | 18 | 19 | 20 | example 4 |
| View | Front | ⊚ | ⊚ | ⊚ | ⊚ | ⊚ | X |
| angle | 30° | ⊚ | ⊚ | ⊚ | ⊚ | ⊚ | X |
| | 60° | ⊚ | ⊚ | ⊚ | ⊚ | ⊚ | X |

⊚: No lamp image is viewed.
◯: Lamp image is viewed when carefully viewed.
X: Lamp image is blurred but viewed as remaining.

### Examples 21 to 25)

Liquid crystal display devices were prepared similarly to Examples 6 to 10 except that two prism sheets having the vertex angle of 95° were used as the light deflecting means, and the presence or absence of lamp images was visually observed at the predetermined view angles. The results are shown in Table 7.

### Reference Example 5

A liquid crystal display device was prepared similarly to Example 21 except that the second light diffusing plate was not bonded to the light emitting surface side of the second polarizing plate, and the presence or absence of lamp images was visually observed at the predetermined view angles. The results are shown in Table 7 together.

TABLE 7

| | | Example | Example | Example | Example | Example | Reference |
|---|---|---|---|---|---|---|---|
| | | 21 | 22 | 23 | 24 | 25 | example 5 |
| View | Front | ⊚ | ⊚ | ⊚ | ⊚ | ⊚ | X |
| angle | 30° | ⊚ | ⊚ | ⊚ | ⊚ | ⊚ | X |
| | 60° | ⊚ | ⊚ | ⊚ | ⊚ | ⊚ | X |

⊚: No lamp image is viewed.
◯: Lamp image is viewed when carefully viewed.
X: Lamp image is blurred but viewed as remaining.

### Examples 26 to 30

Liquid crystal display devices were prepared similarly to Examples 11 to 15 except that two prism sheets having the vertex angle of 95° were used as the light deflecting means, and the presence or absence of lamp images was visually observed at the predetermined view angles. The results are shown in Table 8.

### Reference Example 6

A liquid crystal display device was prepared similarly to Example 26 except that the second light diffusing plate was not bonded to the light emitting surface side of the second polarizing plate, and the presence or absence of lamp images was visually observed at the predetermined view angles. The results are shown in Table 8 together.

TABLE 8

| | | Example | Example | Example | Example | Example | Reference |
|---|---|---|---|---|---|---|---|
| | | 26 | 27 | 28 | 29 | 30 | example 6 |
| View | Front | ⊚ | ⊚ | ⊚ | ⊚ | ⊚ | X |
| angle | 30° | ⊚ | ⊚ | ⊚ | ⊚ | ⊚ | X |
| | 60° | ⊚ | ⊚ | ⊚ | ⊚ | ⊚ | X |

⊚: No lamp image is viewed.
◯: Lamp image is viewed when carefully viewed.
X: Lamp image is blurred but viewed as remaining.

### Examples 31 to 35

Liquid crystal display devices were prepared similarly to Examples 1 to 5 except that two prism sheets having the vertex angle of 100° were used as the light deflecting means, and the presence or absence of lamp images was visually observed at the predetermined view angles. The results are shown in Table 9.

### Reference Example 7

A liquid crystal display device was prepared similarly to Example 31 except that the second light diffusing plate was not bonded to the light emitting surface side of the second polarizing plate, and the presence or absence of lamp images was visually observed at the predetermined view angles. The results are shown in Table 9 together.

TABLE 9

| | | Example | Example | Example | Example | Example | Reference |
|---|---|---|---|---|---|---|---|
| | | 31 | 32 | 33 | 34 | 35 | example 7 |
| View | Front | ⊚ | ⊚ | ⊚ | ⊚ | ⊚ | X |
| angle | 30° | ⊚ | ⊚ | ⊚ | ⊚ | ⊚ | X |
| | 60° | ◯ | ⊚ | ⊚ | ⊚ | ⊚ | X |

⊚: No lamp image is viewed.
◯: Lamp image is viewed when carefully viewed.
X: Lamp image is blurred but viewed as remaining.

### Examples 36 to 40

Liquid crystal display devices were prepared similarly to Examples 6 to 10 except that two prism sheets having the vertex angle of 100° were used as the light deflecting means, and the presence or absence of lamp images was visually observed at the predetermined view angles. The results are shown in Table 10.

### Reference Example 8

A liquid crystal display device was prepared similarly to Example 36 except that the second light diffusing plate was not bonded to the light emitting surface side of the second polarizing plate, and the presence or absence of lamp images was visually observed at the predetermined view angles. The results are shown in Table 10 together.

TABLE 10

| | | Example | Example | Example | Example | Example | Reference |
|---|---|---|---|---|---|---|---|
| | | 36 | 37 | 38 | 39 | 40 | example 8 |
| View | Front | ⊚ | ⊚ | ⊚ | ⊚ | ⊚ | X |
| angle | 30° | ⊚ | ⊚ | ⊚ | ⊚ | ⊚ | X |
| | 60° | ◯ | ⊚ | ⊚ | ⊚ | ⊚ | X |

⊚: No lamp image is viewed.
◯: Lamp image is viewed when carefully viewed.
X: Lamp image is blurred but viewed as remaining.

### Examples 41 to 45

Liquid crystal display devices were prepared similarly to Examples 11 to 15 except that two prism sheets having the vertex angle of 100° were used as the light deflecting means, and the presence or absence of lamp images was visually observed at the predetermined view angles. The observation results are shown in Table 11.

### Reference Example 9

A liquid crystal display device was prepared similarly to Example 41 except that the second light diffusing plate was not bonded to the light emitting surface side of the second polarizing plate, and the presence or absence of lamp images was visually observed at the predetermined view angles. The results are shown in Table 11 together.

TABLE 11

| | | Example | Example | Example | Example | Example | Reference |
|---|---|---|---|---|---|---|---|
| | | 41 | 42 | 43 | 44 | 45 | example 9 |
| View | Front | ⊚ | ⊚ | ⊚ | ⊚ | ⊚ | X |
| angle | 30° | ⊚ | ⊚ | ⊚ | ⊚ | ⊚ | X |
| | 60° | ◯ | ⊚ | ⊚ | ⊚ | ⊚ | X |

⊚: No lamp image is viewed.
◯: Lamp image is viewed when carefully viewed.
X: Lamp image is blurred but viewed as remaining.

### INDUSTRIAL APPLICABILITY

The liquid crystal display device according to the present invention can relieve the lamp images without lowering the utilization efficiency of the light emitted from the back light device.

### REFERENCE SIGNS LIST

1 Liquid crystal cell
2 Backlight device
3 First light diffusing plate (first light diffusing means)
4a, 4b Prism film (light deflecting means)
5 First polarizing plate
6 Second polarizing plate
7 Second light diffusing plate (second light diffusing means)
72 Light diffusing layer
721 Translucent resin
722 Translucent fine particle

1. A liquid crystal display device, comprising, in sequence:
a back light device;
a first light diffusing means;
a light deflecting means;
a first polarizing plate;
a liquid crystal cell having a liquid crystal layer provided between a pair of substrates;
a second polarizing plate; and
a second light diffusing means,
wherein the first polarizing plate and the second polarizing plate are arranged so that absorption axes thereof are in crossed Nicol relation,
wherein the first light diffusing means has a characteristic that, when parallel light is made incident from the back face of the first light diffusing means in the direction of the perpendicular of the back face, the ratio (I₂₀/I₀) between the intensity (I₂₀) of the transmitted light emitted in the direction forming an angle of 20° with respect to the direction of the perpendicular, and the intensity (I₀) of the transmitted light emitted in the direction forming an angle of 0° with respect to the direction of the perpendicular is 30% or less, and
the second light diffusing means has a light diffusing layer comprising a translucent resin and translucent fine particles dispersed in the translucent resin.

2. The liquid crystal display device according to claims 1,
wherein the first light diffusing means is a light diffusing plate comprising:
a light diffusing layer containing a translucent resin and a light diffusing agent dispersed in the translucent resin; and
a surface layer provided on one surface or both surfaces of the light diffusing layer, and
wherein the ten-point mean roughness of at least one surface of the surface layers is in a range of 20 to 60 μm.

3. The liquid crystal display device according to claim 2,
wherein the surface layer is provided on the surface of the light diffusing layer, the surface facing the light deflecting means.

4. The liquid crystal display device according to claim 1,
wherein the light deflecting means has a plurality of prism films provided on a light-exiting surface with a plurality of linear prisms each having a polygonal and tapered cross-section at predetermined intervals, and
wherein the plurality of prism films are arranged so that a ridge line direction of linear prisms of one prism film is different from that of the other prism films.

5. The liquid crystal display device according to claim 1,
wherein the light diffusing layer of the second light diffusing means is formed on the surface of a base film, and
the average particle size of the translucent fine particles exceeds 5 μm, and
the content of the translucent fine particles is in a range of 25 to 50 parts by mass with respect to 100 parts by mass of the translucent resin.

6. The liquid crystal display device according to claim 1,
wherein the light diffusing layer of the second light diffusing means is formed on the surface of a base film, and
the average particle size of the translucent fine particles is 2 μm to 5 μm, and
the content of the translucent fine particles is in a range of 35 to 60 parts by mass with respect to 100 parts by mass of the translucent resin.
